(19) United States
(12) Patent Application Publication
(10) Pub. No.: US 2008/0190376 A1
(43) Pub. Date: Aug. 14, 2008

(54) Self cleaning pet fur stripping comb

(76) Inventor: Evan I. Matsumoto, Burien, WA (US)

Correspondence Address: Evan Matsumoto, 14407 2nd Avenue S.W., Burien, WA, 98166, US

(21) Appl. No.: 11/706,594

(22) Filed: Feb. 14, 2007

(51) Int. Cl. A01K 13/00

(52) U.S. Cl. 119/614; 119/618; 119/628

(57) ABSTRACT

A pet grooming tool, for use with a furry pet such as a dog or cat having loose hair and non-loose hair, is adapted for removing the loose hair from the pet. The grooming tool comprises a sharp edged comb with short tines mounted in front of an atrium open near the comb, and is also connected to a suction hose attached to a vacuum cleaner or similar.

The comb is drawn through the pet's hair where it pulls loose undercoat and guard hairs, fleas, ticks, dander, and other items out of the animal's fur. When the tines are full, the comb is tipped on its trailing side and passed over a stripping pad or the animals hide. This pulls the hair mass out of the tines and deposits it at the entrance of the suction nozzle from whence it is whisked away by vacuum to a collection chamber.

### RELATED APPLICATIONS

Provisional Application Ser. No. 60/636,443 Filed on Dec. 15, 2004 titled APPARATUS AND METHOD FOR PET GROOMING AND HOUSEKEEPING and Regular application Ser. No. 11/298,860, APPARATUS AND METHOD FOR PET GROOMING AND HOUSEKEEPING filed on Dec. 9, 2005 both by Evan Matsumoto. Both are hereby incorporated by reference into this, the present, disclosure.

### U.S. GOVERNMENT INTEREST IN THE INVENTION

None

### BACKGROUND OF THE INVENTION

1. Field of the Invention

This invention relates to animal, particularly pet, grooming tools for removing loose undercoat hair from a furry pet such as cats, dogs, horses, and others.

2. Description of Related Art

The patent literature has several combing devices designed to remove loose undercoat hair from furry animals. One, U.S. Pat. No. 7,077,076 by Angela Porter, et. al., July 2006, is quite effective at pulling loose hair. However, the hair has to be manually removed from the comb and discarded. When used on long hair dogs, it leaves a pile of hair on the floor and so much fine fly fiber that the groomer wears a face mask to protect his lungs. The dog is not protected and sneezes, disrupting the process and perhaps motivating the dog to bolt.

U.S. Pat. No. 7,150,2007 by James Freidell describes at FIGS. 1, 2, and 3 and associated text (columns 3 and 4, combs combined with vacuum through a tubular handle. Freidell's remaining figures and text have no relationship to the present invention. Freidell places one or more blades across the opening of the bell end of the tubular handle piece. The blades have a sharpened serrated edge which can cut hair, and are short and rounded enough to not capture the released hair, thus the vacuum can whisk away the cut hair. Freidell's tool is patterned after conventional upholstery brushes, which because of the small entrance generate hissing noises palpable suction on the skin which are frightening to animals, especially so with cats. The present invention has a large opening low velocity air flow, and sculpted transitions particularly adapted for smooth air flow with minimal noise generation.

Freidell mentions using a blade similar to a hair clipper blade. However, when such a blade is located within the air channel, the air will now strip off the loosened hair which is one of his stated objects. In fact, the hair will be wrapped around and bound more tightly to the blade tines. This will require the operator to manually strip the tines with his fingers. The present invention permits sweeping the hair off the tines and into the collection means in one quick one-handed motion.

U.S. Pat. No. 6,055,938 by Michael Klein, describes a grooming tool with vacuum clearing of pet detritus. Klein has a blade similar in shape and tooth construction to a common curry comb, and a vacuum attachment with a splayed nozzle opening quite close to the inner side of the curry comb. Klein also has a cover that encloses the comb and nozzle. This puts the curry comb inside the vacuum affected volume. The cover is not directly connected to the vacuum conduits as in the present invention, but form a chamber in which the vacuum nozzle and comb reside.

A curry comb like Klein's or the scalloped blades described by Freidell do not reach deeply into the animals fur, thus they require many strokes which even then do not do a thorough job of removing the loose fur. Furthermore, the short reach and wide spacing is not capable of collecting insects deep in the coat, which is where fleas hang out.

The longer and closely spaced tines of the present invention do reach more deeply, and to the bottom of some animal's coat. Also the hair picked up by the tines ensnares fleas, reducing their mobility long enough to be drawn into the evacuation suction air stream.

3. Objects of the Invention

It is an object of the invention to have a process for automatically cleaning the tines of the grooming tool and whisking the shed hair, insects, and dander safely and quickly away to a collection bin.

### DEFINITIONS

The wording and phrasing used in this disclosure and the claims are to be interpreted broadly and include synonyms and near synonyms.

Fur and Hair are to be interpreted as synonyms having equal meaning.

Vacuum cleaner any device and its associated hoses intended to move loose material through a hose under the influence of air propelled by a fan or impeller.

Tube, vacuum conduit, hose are used interchangeably unless differentiated by contextual usage.

Apparatus and tool are used interchangeably to name the fur stripping comb as a unit, and to delineate between the whole tool and the comb (tined) element of the tool.

### BRIEF SUMMARY OF THE INVENTION

A comb with short tines having a flat back side and sharp edges at the back edge of the tines is attached to a tube adapted to attach to a vacuum cleaner hose, which preferably is then connected to a collection bucket that receives hair from the comb, thence connected to a vacuum source. The hair being propelled from the comb to the collection bucket. It is not necessary to use the collection bucked, the full description of which is to be found in the related application identified in “Related Applications”. However, the bucket serves two specific purposes. 1. It provides a muffling function to reduce the vacuum fan noise which is frightening to animals, especially cats; and 2. To collect the removed hair, bugs, dirt, etc in a convenient place which is easily completely emptied and washable between pet grooming sessions. Without the bucket, hair must be collected in a filtered container at the vacuum source. This container should not be allowed to fill completely as it will clog the machinery.

Cleaning of the comb is accomplished simply by wiping it backwards over the animal's hide. This will drop the hair off the comb tines in front of the air inlet nozzle where it is picked up and whisked away, all in one easy, natural motion. The wiping may also be done on a separate pad or piece of carpet strategically placed for easy access or with the operators fingers.

### BRIEF DESCRIPTION OF THE FIGURES

FIG. 1 is a side view of the fur combing invention

FIG. 2 is a view of the underside of the fur combing invention.

FIG. 3 is a detail of the combing blade

FIG. 4 is a cut-away view of the combing blade.

FIG. 5 shows the furcomb being used with the low noise, remote debris collection system.

### TABLE OF IDENTIFIED DETAILS

1. The fur combing invention.

2. The joining conduit

3. The adapter to a vacuum conduit

4. The atrium opening

5. Comb tines

6. Comb block

7. Comb mounting hole

8. Vacuum passage, interior bore of joining conduit

9. Joining conduit shaped entrance

### DETAILED DESCRIPTION OF THE INVENTION

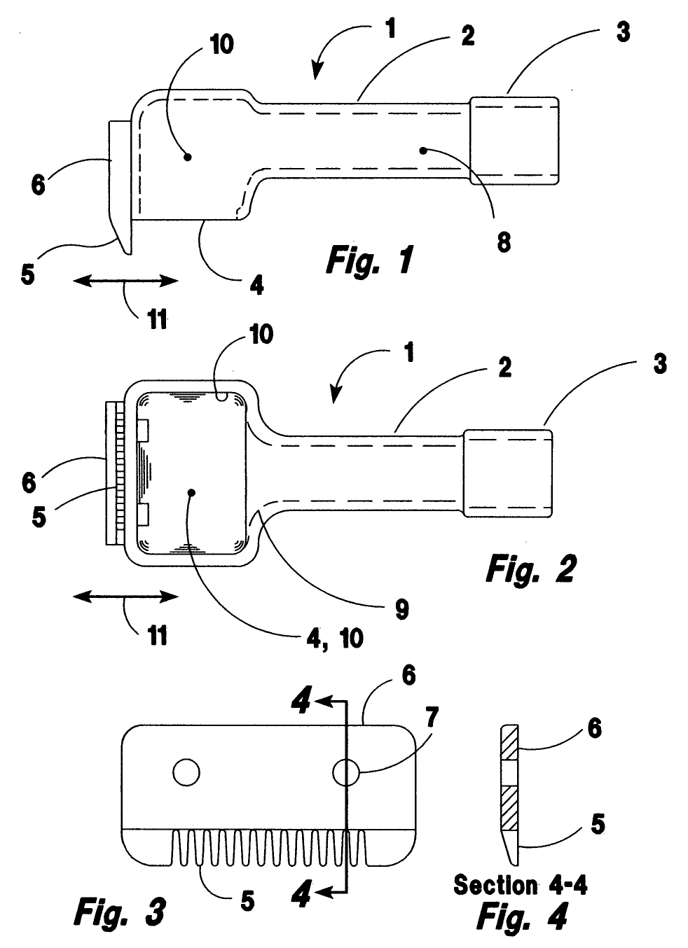

Referring to FIG. 1, the pet fur stripping comb is adapted to remove loose hair from the undercoat of a furry animal, particularly a dog or cat while not pulling or cutting non-loose hair. The comb may also find use in the leather industry for preparing hides to be tanned with the hair attached.

Referring to FIGS. 1 and 2, the fur stripping comb is shown and identified by the indicator numeral 1. The combing tool comprises a hollow generally tubular body 2 adapted 3 to receive the attachment end of a vacuum cleaner hose. The end opposite the vacuum conduit receiving adapter terminates in an atrium 3 open 4 on the underside immediately behind the tines 6 of the comb.

Referring to FIGS. 3 and 4, the operative comb 6 is a flat steel block (blade) with tapered tines 5 spaced approximately 1/16 inch O/C along one edge. Spacing may be as little as 1/32 inch O/C, the spacing of a standard flea comb, which tugs on the hair, and agitates the animal. Much larger as in many stiff brushes will not pick up hair and fleas as efficiently. The tines taper from the front surface of the block toward the back surface of the block and also from the root of the tine to the tip of the tine. The tine edges on the front surface of the block are preferred to be rounded, but may be planed to have sharp corners. The back surface of the tines is ground flat so the tines have sharp edges on adjacent tine faces. The comb will work without the sharp edges, but not as effectively. The sharp edges provide additional friction on loose hair to prevent loose hair from passing between the tines, but not enough friction to cut non-loose hair.

The blade block 6 is then preferably attached to the front of the atrium by screws through holes 7. Other methods of attachment are intended to be within the scope of this disclosure.

Suitable combing blocks may be obtained by removing one of the blades of an ordinary reciprocating grooming clipper or alternatively commercially as a component from the Sunbeam Corporation model Oster A5 (tm) blade.

When the combing assembly engages a pet and the tines drawn through the pet's fur in the direction of the atrium, the tines pick up hair which wraps over the tines and streams outwardly in the direction away from the atrium. The tubular portion between the atrium and the vacuum hose connection serving as a handle for gripping the combing assembly.

The tines quickly load with hair and must be cleaned. Cleaning may be done with the operator's fingers, or by swiping the front edge of the blade across a pad having a Knap or even across the pets coat. The hair is quickly stripped from the tines and automatically presented to the moving air entering the atrium, from which it is whisked away by the vacuum propelled air stream for collection in a remote bucket.

Air and machinery noises frighten animals. As also, in many cases, the sensation of suction on the skin. Therefore, the fur combing system of the present invention has been specifically designed and adapted to reduce the fright factor associated with animal grooming. The fur comb assembly has large, shaped, air passages to reduce the intensity and pitch of air being drawn into the atrium and conduits. The atrium opening 4 has an area at least 1.5 times the area of the joining tube 8 and the entrance 9 to joining tube 8 is flared to facilitate the movement of air from the atrium without producing a vena contracta pinching zone and unnecessary noise. The flaring is preferred to be logarithmic shape, but may be conical, elliptical, parabolic, or even mostly sections of a circle.

The large opening of the atrium prevents suction sensation and whistling and hissing of air being drawn into the assembly. The remote collection bucket and the longer vacuum hoses have muffling characteristics to nearly eliminate motor and fan noise from traveling down the hoses.

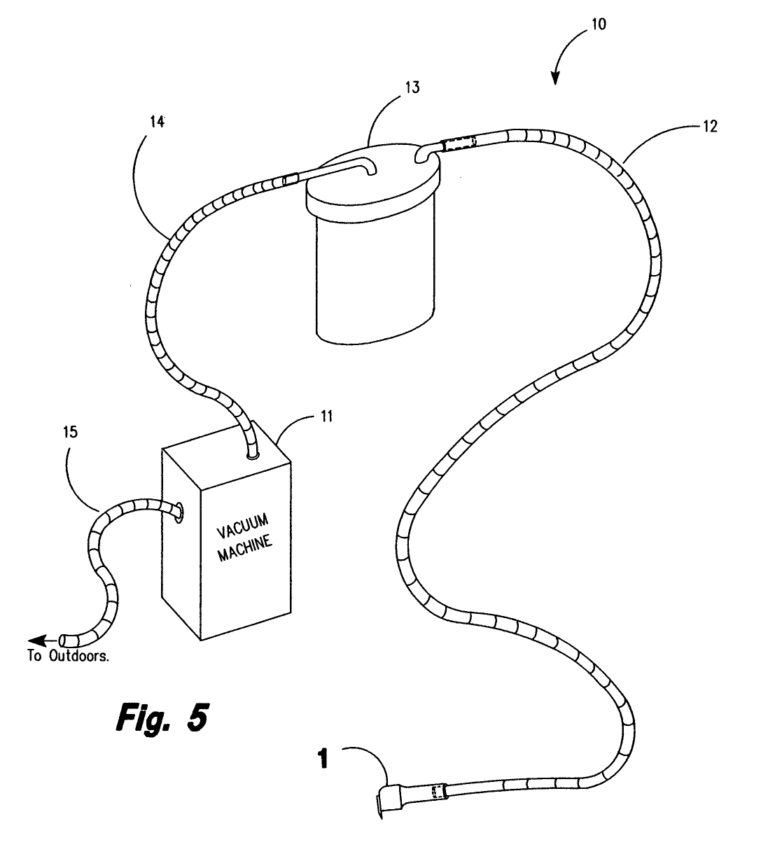

As described in application Ser. No. 11/298,860, and shown in FIG. 5 as 10, the vacuum machine 11 is preferred to be in another room from the grooming station. The grooming station is serviced by a long vacuum conduit 12, shown as a flexible hose, but may be in part hard piping. The long hose also tends to muffle the vacuum machinery sounds more than does hard piping. Long hose 12 terminates in a collection bucket 13, which is in turn connected to the vacuum machine 11 by a shorter hose 14. The vacuum machine is preferred to be vented to the outdoors 15, which also carries some of the machinery noise away from the pet.

The action of the fur combing tool entraps fleas and ticks in the hair being caught up by the tines. Without the immediate whisking away of the hair mass, parasites such as these may escape into the grooming site. Furthermore, by immediately removing the hair and debris from the site, potential allergic reactions of the groomer or others in the vicinity is greatly reduced.

Insecticides such as mothballs may be in the bottom of the collection bucket 13 and at any secondary filter in the vacuum machine.

### Alternative Embodiments and Variations of the Invention

The body of the fur combing apparatus may be made of metal or plastic. The comb itself 5,6 may be plastic or other metals, with hardened steel being the preferred material.

The exterior surfaces of the atrium 9 and the joining tube 2 may be treated or covered with a material that enhances the gripability of the combing apparatus. Holding the apparatus by the atrium gives more flexibility to the combing action provided by the operator's hand. It and tube 2 together provide a variety of gripping positions to help relieve the operator of repetitive motion problems.

How to Use the Invention

The fur stripping comb is attached to a vacuum cleaner, preferably through an intermediate collection bucket. The comb is then pulled through the pet's fur in the direction of the tines sharpened edges thereby pulling loose undercoat and guard hairs, fleas, ticks, dander, and other items out of the animal's fur. When the tines are full, the comb is tipped onto its trailing side and passed over a stripping pad or the animals hide. This pulls the hair mass out of the tines and deposits it at the entrance of the suction nozzle from whence it is whisked away by vacuum driven air flow to a collection chamber.

Blade 6 may be turned around so that the flat sides of the tines face away from the atrium. The combing apparatus is then pushed instead of being pulled. At the end of the push stroke, the combing apparatus is tipped upward so the tines become nearly parallel to the animal being groomed and then pushed a short distance more against the animal. This will strip the caught up hair from the tines and deposit it at the entrance 4 of the atrium.

These together with other objects of the invention, along with the various features of novelty which characterize the invention, are pointed out with particularity in the claims annexed to and forming a part of this disclosure. For a better understanding of the invention, is operating advantages and the specific objects attained by its uses, reference should be made to the accompanying drawings and descriptive matter in which there is illustrated preferred embodiments of the invention.

It is recognized that one skilled in the art will perceive other embodiments and variants in the spirit and nature of the invention. It is intended that such embodiments and variants be included within the monopoly extended by patent.

I claim:

1. A combing tool for stripping loose fur from an animal, and having vacuum assisted removal of loosed hair comprising in combination:
a. a comb having closely spaced tines on one edge, and
b. a rectangular atrium closed on its top, two opposite sides, and front side, and open on the bottom, and on the back side opposite the front side, a vacuum conduit is fixedly attached and adapted to draw air and entrained animal detritus into the open bottom and out through said conduit, and
c. said conduit has on the end opposite the atrium, an adapter for removably attaching a hose from a vacuum source, and
d. where said comb tines extend in front of and below said atrium bottom, whereby when the comb engages the animal's fur and is drawn through the fur in the direction of the atrium, loose hair is gathered on the comb tines, from whence the vacuum driven air flowing through the atrium whisks away the loosened fur and detritus to a collection container.

2. The combing tool of claim 1 where said tines have the interdigital corners on the atrium attached side sharpened.

3. The combing tool of claim 1 where said tines have the interdigital corners on the side opposite the atrium attachment sharpened.

4. The combing tool of claim 1 where the end of the said vacuum conduit is connected to said atrium with curved surfaces adapted to guide the moving air to minimize vena contracta and the production of noise.
